(19) United States
(12) Patent Application Publication
(10) Pub. No.: US 2018/0100928 A1
(43) Pub. Date: Apr. 12, 2018

(54) METHODS CIRCUITS DEVICES ASSEMBLIES SYSTEMS AND FUNCTIONALLY ASSOCIATED MACHINE EXECUTABLE CODE FOR ACTIVE SCENE SCANNING

(71) Applicant: INNOVIZ TECHNOLOGIES LTD., Kfar Saba (IL)

(72) Inventors: Omer Keilaf, Kfar Saba (IL); Oren Buskila, Hod Hasharon (IL); Amit Steinberg, Adanim (IL); David Elooz, Kfar Haroeh (IL); Nir Osiroff, Givatayim (IL); Ronen Eshel, Givatayim (IL); Yair Antman, Petach Tikva (IL); Guy Zohar, Netanya (IL); Yair Alpern, Kiryat Tivon (IL); Moshe Medina, Haifa (IL); Smadar David, Qiryat Ono (IL); Pavel Berman, Ramat Gan (IL); Oded Yeruhami, Tel Aviv (IL); Julian Vlaiko, Kfar Saba (IL)

(21) Appl. No.: 15/391,916

(22) Filed: Dec. 28, 2016

Related U.S. Application Data
(60) Provisional application No. 62/405,928, filed on Oct. 9, 2016.

(51) Int. Cl. G01S 17/93; G01S 17/89; G01S 17/42; G01S 7/487; G01S 7/481

(52) U.S. Cl. CPC G01S 17/936; G01S 17/89; G01S 7/4817; G01S 7/487; G01S 17/42

(57) ABSTRACT

Disclosed is a scanning device including a photonic emitter assembly (PTX) to emit at least one pulse of inspection photons in accordance with at least one adjustable pulse (generation) parameter, a photonic reception and detection assembly (PRX) to receive reflected photons reflected back from an object, the PRX including a dynamic detector to detect the reflected photons based on one or more adjustable detector parameter, the detector further configured to produce a detected scene signal, and a closed loop controller to control the PTX and PRX and to receive a PTX feedback and a PRX feedback, the controller further comprising a situational assessment unit to receive the detected scene signal from the detector and produce a scanning plan and update the at least one pulse parameter and at least one detector parameter at least partially based on the scanning plan.

### RELATED APPLICATIONS

The present application claims priority from U.S. Provisional Patent Application No. 62/405,928, entitled: “Closed loop scanning LiDAR system based on MEMS and SPAD array”, filed on Oct. 9, 2016, which is hereby incorporated by reference into the present application in its entirety.

### FIELD OF THE INVENTION

The present invention relates generally to the field of scene scanning. More specifically, the present invention relates to methods circuits devices assemblies systems and functionally associated machine executable code for active scene scanning.

### BACKGROUND

Lidar which may also be called LADAR is a surveying method that measures distance to a target by illuminating that target with a laser light. Lidar is sometimes considered an acronym of “Light Detection and Ranging”, or a portmanteau of light and radar, and is used with terrestrial, airborne, and mobile applications.

Autonomous Vehicle Systems—are directed to vehicle level autonomous systems involving a LiDAR system. An autonomous vehicle system stands for any vehicle integrating partial or full autonomous capabilities.

Autonomous or semi-autonomous vehicles are vehicles (such as motorcycles, cars, buses, trucks and more) that at least partially control a vehicle without human input. The autonomous vehicles, sense their environment and navigate to a destination input by a user/driver.

Unmanned aerial vehicles, which may be referred to as drones are aircrafts without a human on board. Optionally, the drones may be manned/controlled autonomously or by a remote human operator.

Autonomous vehicles and drones may use Lidar technology in their systems to aid in detecting and scanning a scene/the area in which the vehicle and/or drones are operating in.

LiDAR systems, drones and autonomous (or semi-autonomous) vehicles are currently expensive and non-reliable, unsuitable for a mass market where reliability and dependence are a concern—such as the automotive market.

Host Systems are directed to generic host-level and system-level configurations and operations involving a LiDAR system. A host system stands for any computing environment that interfaces with the LiDAR, be it a vehicle system or testing/qualification environment. Such computing environment includes any device, PC, server, cloud or a combination of one or more of these. This category also covers, as a further example, interfaces to external devices such as camera and car control data (acceleration, steering wheel deflection, reverse drive, etc.). It also covers the multitude of interfaces that a LiDAR may interface with the Host system, such as CAN bus for example

### SUMMARY OF THE INVENTION

The present invention includes methods, circuits, assemblies, devices, systems and functionally associated machine executable code for closed loop dynamic scene scanning.

According to some embodiments, a scanning device may include a photonic emitter assembly (PTX) to emit at least one pulse of inspection photons in accordance with at least one adjustable pulse (generation) parameter, a photonic reception and detection assembly (PRX) to receive reflected photons reflected back from an object, the PRX including a dynamic detector to detect the reflected photons based on one or more adjustable detector parameter, the detector further configured to produce a detected scene signal, and a closed loop controller to control the PTX and PRX and to receive a PTX feedback and a PRX feedback, the controller further comprising a situational assessment unit to receive the detected scene signal from the detector and produce a scanning plan and update the at least one adjustable pulse parameter and at least one detector parameter at least partially based on the scanning plan. The scanning device may include a photonic steering assembly (PSY) and the situational assessment unit may be configured to determine the scanning plan based on a global cost function where the PSY feedback, PRX feedback, PTX feedback, memory information, host feedback and the detected scene signal are used in producing the scanning plan and the host feedback includes an override flag to indicate that the host feedback is to override the other signals and feedbacks

According to some embodiments of the present invention, there may be provided a scanning device including a photonic emitter assembly (PTX), a photonic reception and detection assembly (PRX), a photonic steering assembly (PSY) and a controller adapted to synchronize operation of the PTX, PRX and PSY. The controller may be a situationally aware controller which dynamically adjusts the operational mode and operational/scanning parameters of the PTX, PRX and/or PSY based on one or more detected situational characteristics.

According to some embodiments, a scanning device may include a photonic emitter assembly (PTX) to produce pulses of inspection photons wherein the pulses are characterized by at least one pulse parameter, a photonic reception and detection assembly (PRX) to receive reflected photons reflected back from an object, the PRX including a detector to detect the reflected photons and produce a detected scene signal, a photonic steering assembly (PSY) functionally associated with both the PTX and the PRX to direct the pulses of inspection photons in a direction of an inspected scene segment and to steer the reflection photons back to the PRX, and a closed loop controller to: (a) control the PTX, PRX and PSY, (b) receive the detected scene signal from the detector and (c) update the at least one pulse parameter at least partially based on the detected scene signal.

According to some embodiments, at least one pulse parameter may be selected from the following group: pulse power intensity, pulse width, pulse repetition rate pulse sequence, pulse duty cycle, wavelength, phase and/or polarization.

According to some embodiments, the controller may include a situational assessment unit to receive the detected scene signal and produce a scanning/work plan. The situational assessment unit may receive a PSY feedback from the PSY. The situational assessment unit may receive information stored on a memory. Optionally, the information may be selected from the following list: laser power budget, electrical operational characteristics and/or calibration data. The situational assessment unit may use the PSY feedback to produce the scanning/work plan. Laser power budget may be derived from constraints such as: eye safety limitations, thermal budget, laser aging over time and more.

According to some embodiments, the work plan may be produced based on (a) real-time detected scene signal (b) intra-frame level scene signal and (c) inter-frame level scene signal accumulated and analyzed over two or more frames.

According to some embodiments, the detector may be a dynamic detector having one or more detector parameters and the closed loop controller may update the detector parameters based on the work plan. The detector parameters may be selected from the following group: scanning direction, frame rate, ambient light effects, mechanical static and dynamic impairments, dynamic gating for reducing parasitic light, dynamic sensitivity and/or thermal effects. The PSY may have one or more steering parameters and the closed loop controller may update the steering based on the work plan. The steering parameters may be selected from the following group: scanning method, power modulation, single or multiple axis methods, synchronization components. Optionally, the situational assessment unit may receive a host feedback from a host device and use the host feedback to produce or contribute to the work plan.

According to some embodiments, a method of scanning a scene may include: producing pulses of inspection photons wherein the pulses may be characterized by at least one pulse parameter, receiving reflected photons reflected back from an object; detecting the reflected photons and producing a detected scene signal; and updating at least one pulse parameter based on the detected scene signal.

According to some embodiments, the method may include producing a work plan based on the detected scene signal. Optionally, producing a work plan is also based on a PSY feedback, and may also be based on information stored on a memory such as a look up table or otherwise.

According to some embodiments, the method may include updating one or more detector parameters based on the work plan, and updating steering of the PSY based on the work plan.

According to some embodiments, a vehicle may include a scanning device and a host device to receive a detected scene signal and control the vehicle at least partially based on the detected scene signal and to relay a host feedback to the scanning device. The situational assessment unit of the scanning device may receive a host feedback from the host device and use the host feedback to produce the work plan

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1C show examples of scanning device schematics in accordance with some embodiments;

FIG. 2 shows a scanning system in accordance with some embodiments;

FIGS. 3A&3B show example inspection photonic pulses control signals including examples laser signal in accordance with some embodiments;

FIG. 4 shows an example scanning system in accordance with some embodiments;

FIGS. 5A&5B show example host systems in accordance with some embodiments; and

FIG. 6 shows a flow chart for a method of scanning a scene in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device or circuitry, that manipulate and/or transform data represented as physical, such as electronic, quantities within the computing system's registers and/or memories and/or cells into other data similarly represented as physical quantities within the computing system's cells, memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention may include methods, circuits, devices, assemblies, systems and functionally associated machine executable code for active scene scanning.

According to some embodiments, a scanning device may analyze a changing scene to determine/detect scene elements. When used in conjunction with a host such as a vehicle platform and/or a drone platform, the scanning device may provide a detected scene output. The host device may utilize a detected scene output or signal from the scanning device to automatically steer or operate or control the host device. Furthermore, the scanning device may receive information from the host device and update the scanning parameters accordingly. Scanning parameters may include: adjustable pulse parameters, adjustable detector parameters, adjustable steering parameters and/or otherwise. For example, a scanning device may detect an obstruction ahead and steer the host away from the obstruction. In another example the scanning device may also utilize a turning of a steering wheel and update the scanning device to analyze the area in front of the upcoming turn or if a host device is a drone, a signal indicating that the drone is intended to land may cause the scanning device to analyze the scene for landing requirements instead of flight requirements. According to some embodiments, a scanning device may have hierarchical field of view (FOV) perception capabilities that can be shifted in space and time. These capabilities may enable high performance LiDAR across a very large FOV area by adaptive partitioning into segments of FOVs that are allocated a certain level of quality of service (QoS). It is typically impossible to assign the highest QoS for all segments, therefore the need for an adaptive allocation method will be henceforth described. QoS depends on the signal to noise ratio between the laser pulse transmitted and the laser reflection detected from the target reflection. Different levels of laser power may be applied in different regions in the LiDAR FOV. The levels of power may range from zero up to the maximum power that the laser device is capable of transmitting and/or receiving. QoS has limitations stemming from physical design, eye safety, thermal constraints, cost and form factor and more. Accordingly, a scanning device may be limited by one or more of the following system and/or scene features: horizontal and vertical FOV range; data acquisition rate (e.g. frame rate); resolution (e.g. number of pixels in a frame); accuracy (spatial and temporal); range (effective detection distance) and more.

For clarity, a light source throughout this application has been termed a “laser” however, it is understood that alternative light sources that do not fall under technical lasers may replace a laser wherever one is discussed, for example a light emitting diode (LED) based light source or otherwise. Accordingly, a Lidar may actually include a light source which is not necessarily a laser.

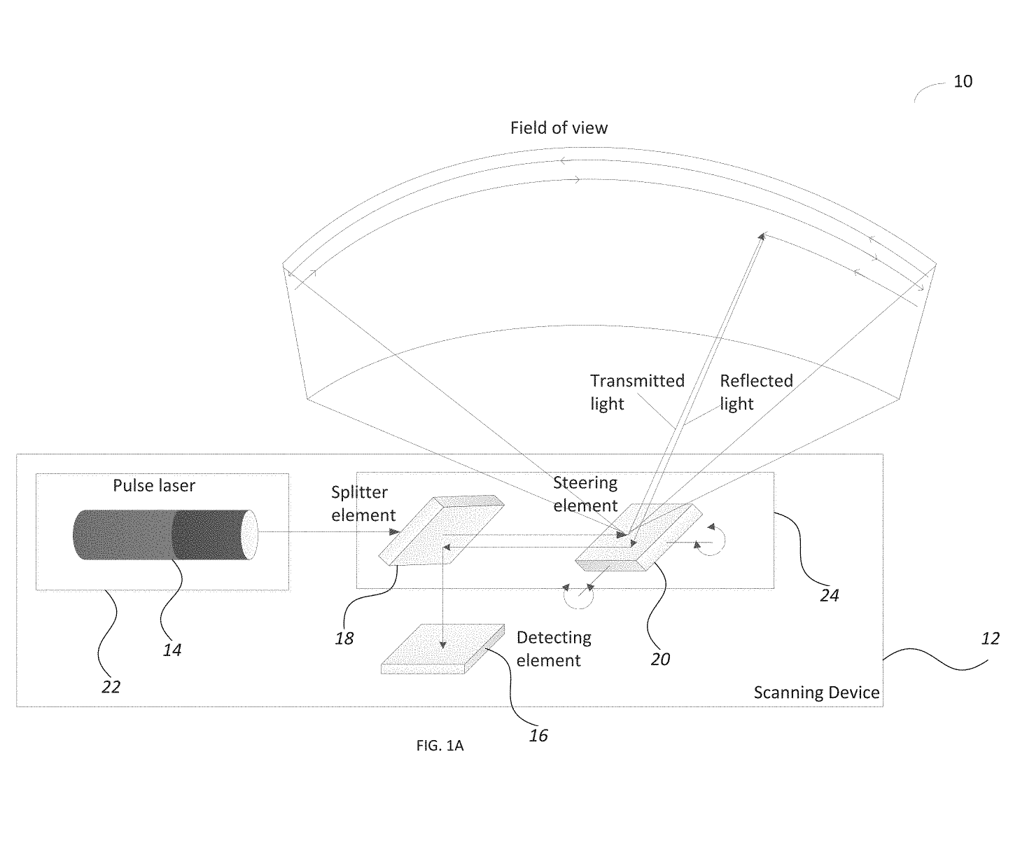

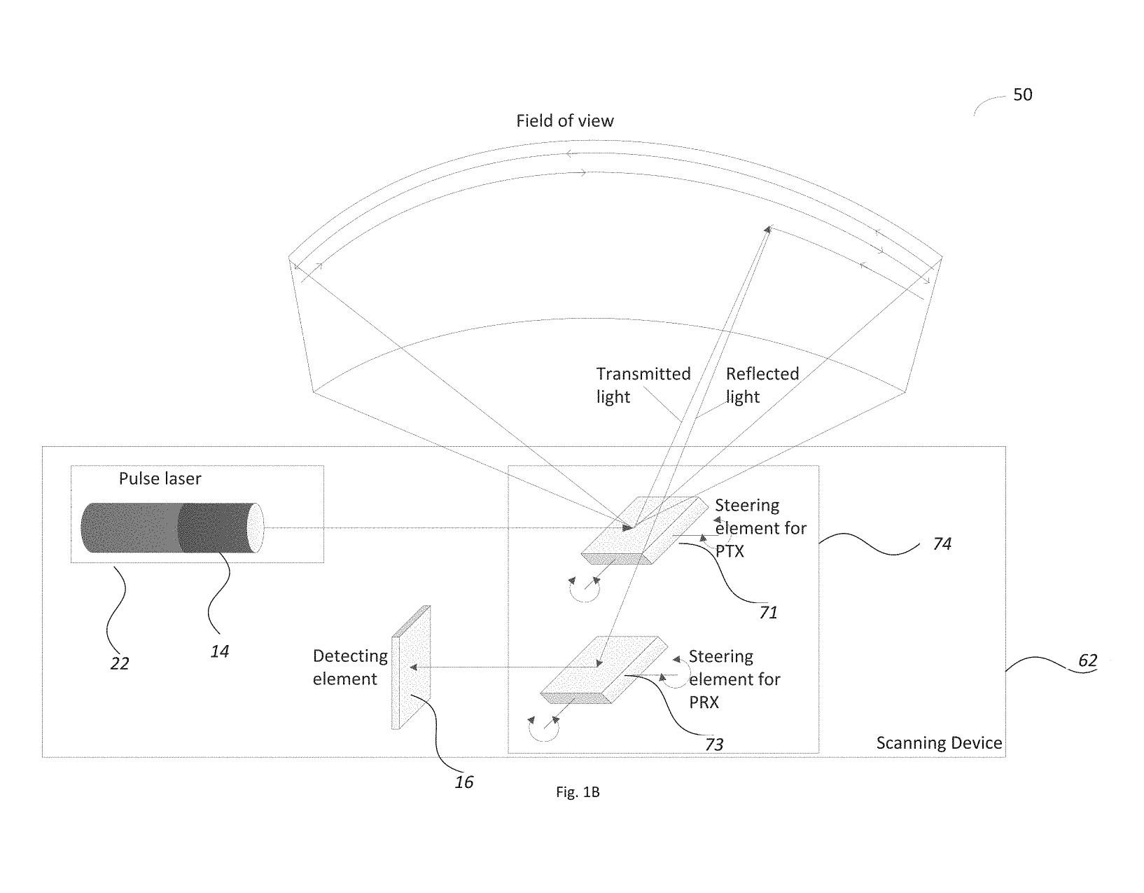

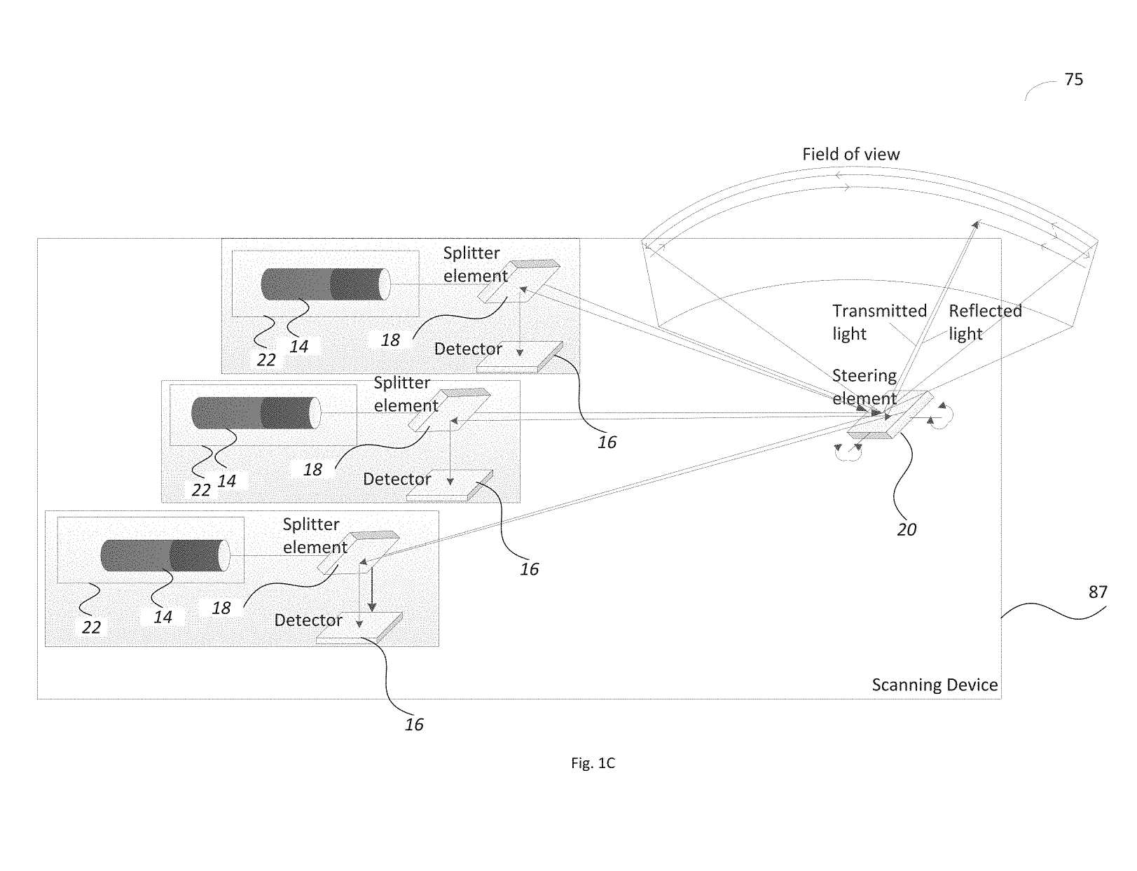

Turning to FIG. 1A, depicted is an example scanning device schematic 10. According to some embodiments, there may be provided a scene scanning device such as scanning device 12 which may be adapted to inspect regions or segments of a scene (shown here is a specific FOV being scanned) using photonic pulses (transmitted light) whose characteristics may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; and/or (f) a situational feature/characteristic of a host platform with which the scanning device is operating. The scene scanning device may be adapted to inspect regions or segments of a scene using a set of one or more photonic transmitters 22 (including a light source such as pulse laser 14), receptors including sensors (such as detecting element 16) and/or steering assemblies 24 (which may include splitter element 18 and steering element 20); whose configuration and/or arrangement may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; and/or (f) a situational characteristic of a host platform with which the scanning device is operating. Active scanning device 12 may include: (a) a photonic emitter assembly 22 which produces pulses of inspection photons; (b) a photonic steering assembly 24 that directs the pulses of inspection photons to/from the inspected scene segment; (c) a photonic detector assembly 16 to detect inspection photons reflected back from an object within an inspected scene segment; and (d) a controller to regulate operation of the photonic emitter assembly, the photonic steering assembly and the operation of the photonic detection assembly in a coordinated manner and in accordance with scene segment inspection characteristics of the present invention at least partially received from internal feedback of the scanning device so that the scanning device is a closed loop dynamic scanning device. A closed loop scanning device is characterized by having feedback from at least one of the elements and updating one or more parameters based on the received feedback. A closed loop system may receive feedback and update the system's own operation at least partially based on that feedback. A dynamic system or element is one that may be updated during operation. Furthermore, scanning device 12 may be characterized in that accumulative feedback from a plurality of elements may be used to update/control parameters of those and other elements.

According to some embodiments, inspection of a scene segment may include illumination of the scene segment or region with a pulse of photons (transmitted light), which pulse may have known parameters such as pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. Inspection may also include detecting and characterizing various aspects of reflected inspection photons, which reflected inspection photons are inspection pulse photons (reflected light) reflected back towards the scanning device (or laser reflection) from an illuminated element present within the inspected scene segment (i.e. scene segment element). Characteristics of reflected inspection photons may include photon time of flight (time from emission till detection), instantaneous power (or power signature) at and during return pulse detection, average power across entire return pulse and photon distribution/signal over return pulse period the reflected inspection photons are a function of the inspection photons and the scene elements they are reflected from and so the received reflected signal is analyzed accordingly. In other words, by comparing characteristics of a photonic inspection pulse with characteristics of a corresponding reflected and detected photonic pulse, a distance and possibly a physical characteristic such as reflected intensity of one or more scene elements present in the inspected scene segment may be estimated. By repeating this process across multiple adjacent scene segments, optionally in some pattern such as raster, lissajous or other patterns, an entire scene may be scanned in order to produce a map of the scene.

The definition according to embodiments of the present invention may vary from embodiment to embodiment, depending on the specific intended application of the invention. For Lidar applications, optionally used with a motor vehicle platform/host and or drone platform/host, the term scene may be defined as the physical space, up to a certain distance, in-front, behind, below and/or on the sides of the vehicle and/or generally in the vicinity of the vehicle or drone in all directions. The term scene may also include the space behind the vehicle or drone in certain embodiments. A scene segment or scene region according to embodiments may be defined by a set of angles in a polar coordinate system, for example, corresponding to a pulse or beam of light in a given direction. The light beam/pulse having a center radial vector in the given direction may also be characterized by angular divergence values, polar coordinate ranges of the light beam/pulse and more.

Turning to FIG. 1B, depicted is an example bistatic scanning device schematic 50. It is understood that scanning device 62 is substantially similar to scanning device 12. However, scanning device 12 is a monostatic scanning device while scanning device 62 is a bistatic scanning device. Accordingly, steering element 74 is comprised of two steering elements: steering element for PTX 71 and steering element for PRX 73. The rest of the discussion relating to scanning device 12 of FIG. 1A is applicable to scanning device 62 FIG. 1B.

Turning to FIG. 1C, depicted is an example scanning device with a plurality of photonic transmitters 22 and a plurality of splitter elements 18 and a plurality of detectors 16. All of the transmitters 22, detectors, 16 and splitters 18 may have a joint steering element 20. It is understood that scanning device 87 is substantially similar to scanning device 12. However, scanning device 87 is a monostatic scanning device with a plurality of transmitting and receiving elements. The rest of the discussion relating to scanning device 12 of FIG. 1A is applicable to scanning device 87 FIG. 1C.

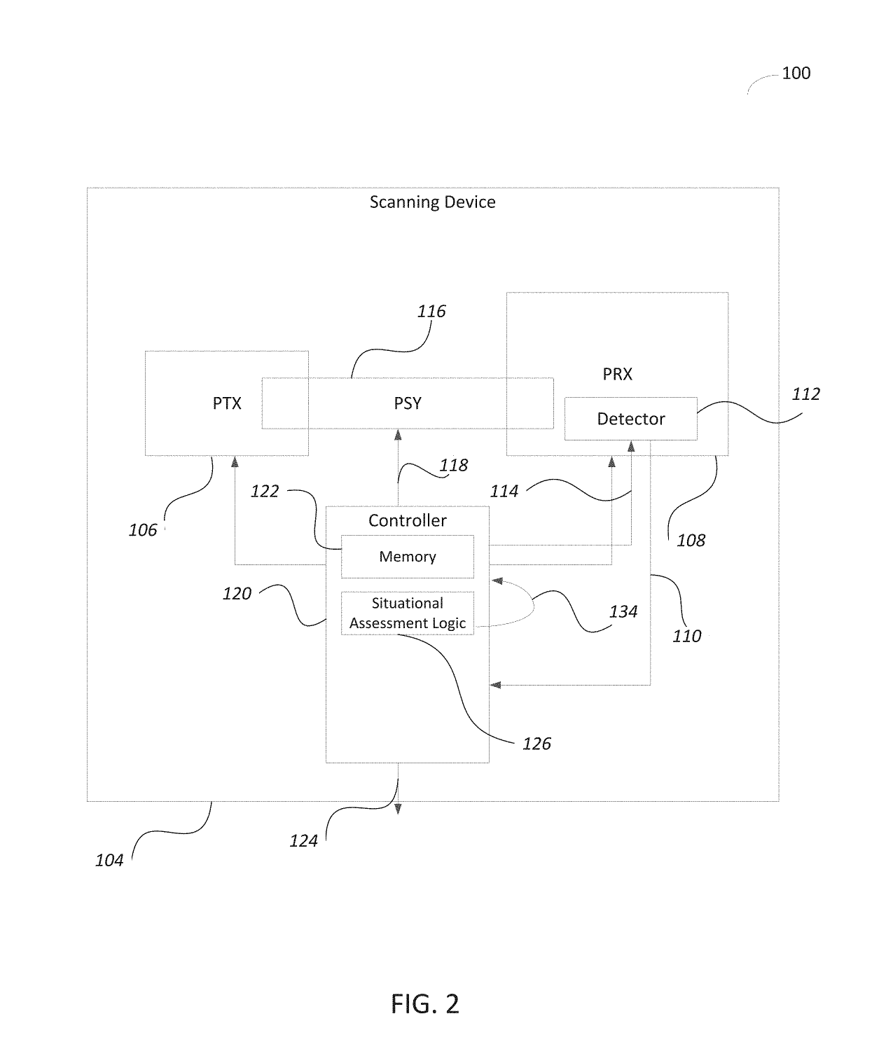

Turning to FIG. 2, depicted is an example scanning system 100 in accordance with some embodiments. Scanning system 100 may be configured to operate in conjunction with a host device. Scanning system 100 may include a scene scanning device such as scanning device 104 adapted to inspect regions or segments of a scene using photonic pulses whose characteristics may be dynamically selected. Scanning device 104 may include a photonic emitter assembly (PTX) such as PTX 106 to produce pulses of inspection photons. PTX 106 may include a laser or alternative light source. The light source may be a laser such as a solid state laser, a high power laser or otherwise or an alternative light source such as, a LED based light source or otherwise. Scanning device 104 may be an example embodiment for scanning device 12 of FIG. 1A and/or scanning device 62 of FIG. 1B and/or scanning device 87 of FIG. 1C and the discussion of those scanning devices is applicable to scanning device 104.

According to some embodiments, the photonic pulses may be characterized by one or more controllable pulse parameters such as: pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and pulse calibration and more. Pulse calibration may include correcting a or compensating for a pulse intensity or direction so that the actual pulse is aligned with an expected/intended pulse to compensate for either differences resulting from production or for changes that may occur (such as degradation) over time.

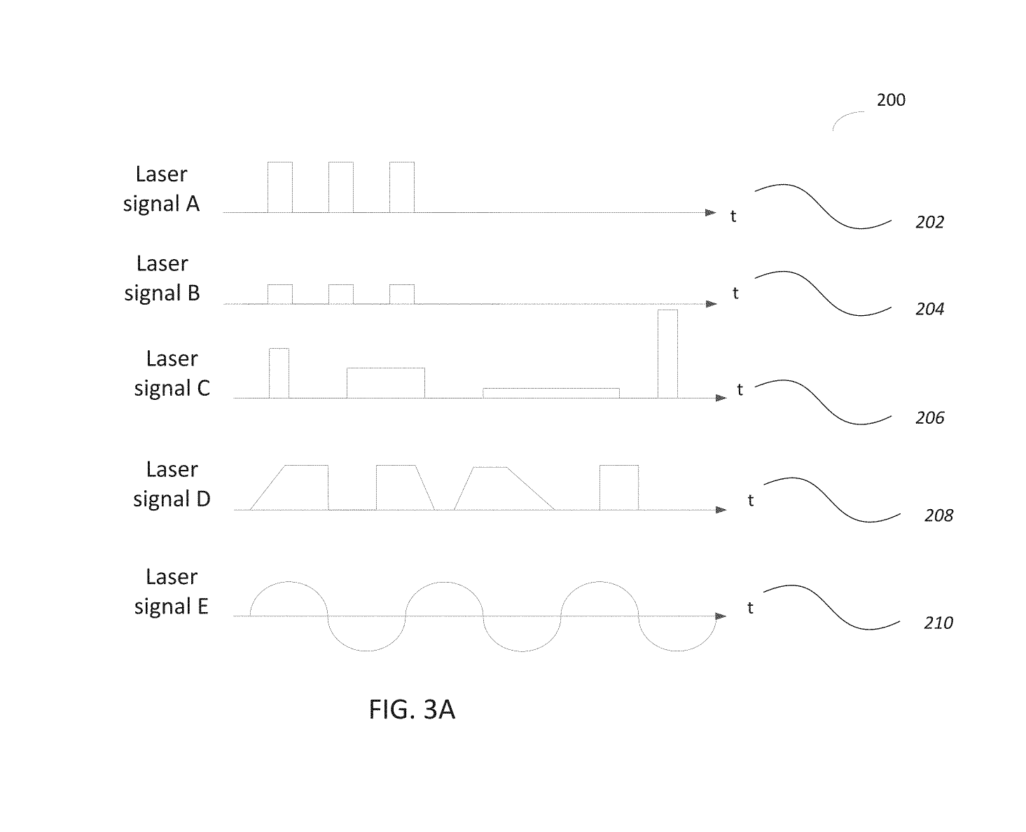

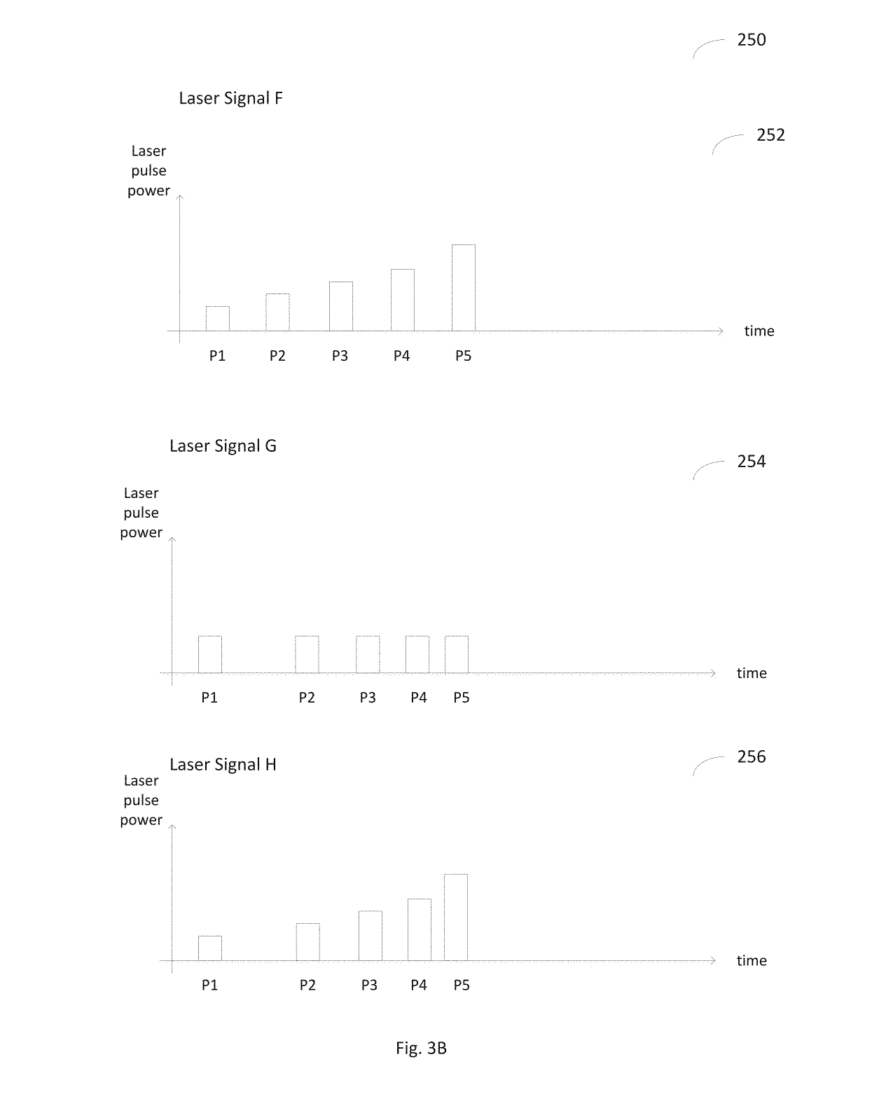

According to some embodiments, the inspection photons may be controlled so that they vary in pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. The photonic pulses may vary between each other and the parameters may change during the same signal. The inspection photonic pulses may be characterized as: sinusoidal, chirp sequences, step functions, pseudo random signals, or linear signals, they may be periodical or fixed or otherwise and/or a combination of these. Examples are shown in FIGS. 3A&3B which depict example inspection photo pulses control signals 200 and 250 including examples laser signal A-laser signal H (202-256, appropriately) depicting the control signal enabling a photonic pulse and determining the intensity, width, repetition rate of the pulse as well as pulse repetition rate and/or pulse sequence.

According to some embodiments PTX 106 laser may operate in different laser modes such as modulated continuous wave (CW), pulsed quasi CW (Q-CW), mode locked, and may include a plurality of laser emitters. Additional examples are shown in FIG. 3B which depicts example inspection photonic pulses control signals 250 including examples laser signal F (252); laser signal G (254) and laser signal H (256) depicting the control signal enabling a photonic pulse and determining the intensity, width, repetition rate of the pulse as well as pulse repetition rate and/or pulse sequence. Laser signal F 252, for example, is characterized by increased power pulses, this type do sequence may be applicable to cover targets at increased ranges. Laser signal G 254, for example, is characterized by a chirp pulse position modulation and may be applicable for increased SNR. Laser signal H 256 may be characterized by a combination of chirp pulse position modulation and increased power range applicable for increased range and increased SNR.

Turning back to FIG. 2, according some embodiments, PTX 106 may include additional elements such as a collimator to compensate for divergence effects of the laser emitter and render the beam into an optimal shape suitable for steering, transmission and detection. PTX 106 may also include a thermoelectric cooler to optimize temperature stabilization as solid state lasers, for example, may experience degradation in performance with temperature increase, so cooling the laser may enable a higher power yield. PTX 106 may also include an optical outlet.

According to some embodiments, PTX 106 may include one or more PTX state sensors to produce a signal indicating an operational state of PTX 106. An operational state of PTX 106 may include information such as power information or temperature information, laser state, laser degradation (in order to compensate for it), laser calibration information and more.

According to some embodiments, scanning device 104 may include a photonic reception and detection assembly (PRX) such as PRX 108 to receive reflected photons reflected back from an object or scene element and produce detected scene signal 110. PRX 108 may include a detector such as detector 112. Detector 112 may be configured to detect the reflected photons reflected back from an object or scene element and produce detected scene signal 110.

According to some embodiments, detected scene signal 110 may include information such as: time of flight which is indicative of the difference in time between the time a photon was emitted and detected after reflection from an object, reflected intensity, polarization values and more.

According to some embodiments, detected scene signal 110 may be represented using point cloud, 3D signal or vector, 4D signal or vector (adding time to the other three dimensions) and more.

According to some embodiments, detector 112 may have one or more updatable detector parameters controlled by detector parameters control 114 such as: scanning direction, frame rate, ambient light effects, mechanical static and dynamic impairments, thermal effects, wear and tear, area of interest, resolution, sensitivity, detector calibration and more. Calibration of detector 112 may include correcting or compensating a detection sensitivity or otherwise so that the actual detection sensitivity is aligned with an expected/intended detection sensitivity to compensate for either differences resulting from production or for changes that may occur (such as degradation) over time.

According to some embodiments, detector parameters control 114 may be utilized for dynamic operation of detector 112 for controlling the updatable detector parameters. For example, scanning direction may be utilized for dynamic allocation of detector power/resolution/sensitivity/resources. Scanning direction may be the expected direction of the associated inspection photons, frame rate may be the laser or PRX's frame rate, ambient light effect may include detected noise photons or expected inspection photons (before they are reflected), mechanical impairments may also be correlated to issues relating to deviation of other elements of the system that need to be compensated for, knowledge of thermal effects may be utilized to reduce signal to noise ratio, wear and tear refers to wear and tear of detector 112 and/or other blocks of the system that detector 112 can compensate for, area of interest may be an area of the scanned scene that is more important and more. Ambient conditions such as fog/rain/smoke impact signal to noise (lifting the noise floor) can be used as a parameter that defines the operating conditions of the detector and also the laser. Another critical element is the gating of the detector in a monostatic design with the purpose of avoiding the blinding of the detector with the initial transmission of the laser pulse—TX/RX co-channel interference.

According to some embodiments, detector 112 may include an array of detectors such as an array of avalanche photo diodes (APD), single photon detection avalanche diodes (SPADs) or a single detecting elements that measure the time of flight from a laser pulse transmission event to the reception event and the intensity of the received photons. The reception event may be the result of the laser pulse being reflected from a target in the FOV present at the scanned angular position of the laser of PTX 106. The time of flight is a timestamp value that represents the distance of the reflecting target, object or scene element to scanning device 104. Time of flight values may be realized by photon detection and counting methods such as: TCSPC (time correlated single photon counters), analog methods for photon detection such as signal integration and qualification (via analog to digital converters or plain comparators) or otherwise.

According to some embodiments, detector 112 may include a full array of single photon detection avalanche diodes which may be partitioned into one or more pixels that capture a fragment of the FOV. A pixel may represent the basic data element that build up the captured FOV in the 3 dimensional space (e.g. the basic element of a point cloud representation) including a spatial position and the reflected intensity value

According to some embodiments, some optional embodiments of detector 112 may include: (a) a two dimensional array sized to capture one or more pixels out of the FOV, a pixel window may contain a fraction of a pixel, one or more pixels or otherwise; (b) a two dimensional array that captures multiple rows or columns in a FOV up to an entire FOV; (c) a single dimensional array and/or (d) a single SPAD element or otherwise.

According to some embodiments, PRX 112 may also include an optical inlet which may be a single physical path with a single lens or no lens at all.

According to some embodiments, PRX 112 may include one or more PRX state sensors to produce a signal indicating an operational state of PRX 112 for example power information or temperature information, detector state and more.

According to some embodiments, scanning device 104 may be a bistatic scanning device where PTX 106 and PRX 108 have separate optical paths or scanning device 104 may be a monostatic scanning system where PTX 106 and PRX 108 have a joint optical path.

According to some embodiments, scanning device 104 may include a photonic steering assembly (PSY), such as PSY 116, to direct pulses of inspection photons from PTX 106 in a direction of an inspected scene and to steer reflection photons from the scene back to PRX 108. PTX 116 may also be in charge of positioning the singular scanned pixel window onto/in the direction of detector 112.

According to some embodiments, PSY 116 may be a joint PSY, and accordingly, may be joint between PTX 106 and PRX 108 which may be a preferred embodiment for a monostatic scanning system

According to some embodiments, PSY 116 may include a plurality of steering assemblies or may have several parts one associated with PTX 116 and another associated with PRX 108. (see also FIGS. 1A-1C).

According to some embodiments PSY 116 may be a dynamic steering assembly and may be controllable by steering parameters control 118. Example steering parameters may include: scanning method that defines the acquisition pattern and sample size of the scene, power modulation that defines the range accuracy of the acquired scene, correction of axis impairments based on collected feedback, calibration of steering to expected characteristics. Calibration may include correcting or compensating a steering axis so that the actual direction is aligned with an expected/intended direction to compensate for either differences resulting from production or for changes that may occur (such as degradation) over time.

According to some embodiments PSY 116 may include: (a) a Single Dual-Axis MEMS mirror; (b) a dual single axis MEMS mirror; (c) a mirror array where multiple mirrors are synchronized in unison and acting as a single large mirror; (d) a mirror splitted array with separate transmission and reception and/or (e) a combination of these and more.

According to some embodiments, if PSY 116 includes a MEMS splitted array the beam splitter may be integrated with the laser beam steering. According to further embodiments, part of the array may be used for the transmission path and the second part of the array may be used for the reception path. The transmission mirrors may be synchronized and the reception mirrors may be synchronized separately from the transmission mirrors. The transmission mirrors and the reception mirrors sub arrays maintain an angular shift between themselves in order to steer the beam into separate ports, essentially integrating a circulator module.

According to some embodiments, PSY 116 may include one or more PSY state sensors to produce a signal indicating an operational state of PSY 116 for example power information or temperature information, reflector state, reflector actual axis positioning, reflector mechanical state and more.

According to some embodiments, PSY 116 may also include a circulator Model/Beam splitter, although it is understood that the splitter may also be part of PRX 108 instead. The beam splitter may be configured to separate the transmission path of PTX 106 from the reception path of PRX 108. In some embodiments the beam splitter may either be integrated in the steering assembly (for example if a splitter array is utilized) or may be redundant or not needed and accordingly the scanning device may not include a beam splitter.

According to some embodiments, the beam splitter of PSY 116 may be a polarized beam splitter (PBS), a PBS integrating a slit, a circulator beam splitter and/or a slit based reflector or otherwise.

According to some embodiments, PSY 116 may include one or more reflective surfaces, each of which reflective surface may be associated with an electrically controllable electromechanical actuator. The reflective surface(s) may be made from polished gold, aluminum, silicon, silver, or otherwise. The electrometrical actuator(s) may be selected from actuators such as stepper motors, direct current motors, galvanometric actuators, electrostatic, magnetic or piezo elements or thermal based actuators. PSY 116 may include or be otherwise associated with one or more microelectromechanical systems (MEMS) mirror assemblies. PSY 116 according to refractive embodiments may include one or more reflective materials whose index of refraction may be electrically modulated, either by inducing an electric field around the material or by applying electromechanical vibrations to the material.

According to yet further embodiments, PSY 116 may include a beam splitter to help separate transmission path from the reception path. Using the same photonic steering assembly may provide for tight synchronization between a direction in which a photonic pulse/beam is steered and emitted by the photonic emitter assembly and a direction of a concurrent FOV of one or more optical sensors of the photonic detection assembly. Shared photonic steering assembly configuration may allow for a photonic detector assembly of a given device to focus upon and almost exclusively to collect/receive reflected photons from substantially the same scene segment being concurrently illuminated by the given device's photonic emitter assembly. Accordingly, as PSY 116 moves, so may a photonic pulse illumination angle along with the FOV angle.

According to some embodiments, scanning device 104 may include a controller to control scanning device 104, such as controller 120. Controller 120 may receive scene signal 110 from detector 112 and may control PTX 106, PSY 116 and PRX 108 including detector 112, based on: (i) information stored in the controller memory 122, (ii) received scene signal 110 and (iii) accumulated information from a plurality of scene signals 110 received over time.

According to some embodiments, controller 120 may process scene signal 110 optionally, with additional information and signals and produce a vision output such as vision signal 124 which may be relayed/transmitted/to an associated host device. Controller 120 may receive detected scene signal 110 from detector 112, optionally scene signal 110 may include time of flight values and intensity values of the received photons. Controller 120 may build up a point cloud or 3D or 2D representation for the FOV by utilizing digital signal processing, image processing and computer vision techniques.

According to some embodiments, controller 120 may include situational assessment logic or circuitry such as situational assessment logic (SAL) 126. SAL 126 may receive detected scene signal 110 from detector 112 as well as information from additional blocks/elements either internal or external to scanning device 104.

According to some embodiments, scene signal 110 may be assessed and calculated with or without additional feedback signals such as a PSY feedback PTX feedback, PRX feedback and host feedback and information stored in memory 122 in a weighted means of local and global cost functions that determine a scanning/work plan such as work plan signal 134 for scanning device 104 (such as: which pixels in the FOV are scanned, at which laser parameters budget, at which detector parameters budget). Accordingly, controller 120 may be a closed loop dynamic controller that receives system feedback and updates the system's operation based on that feedback.

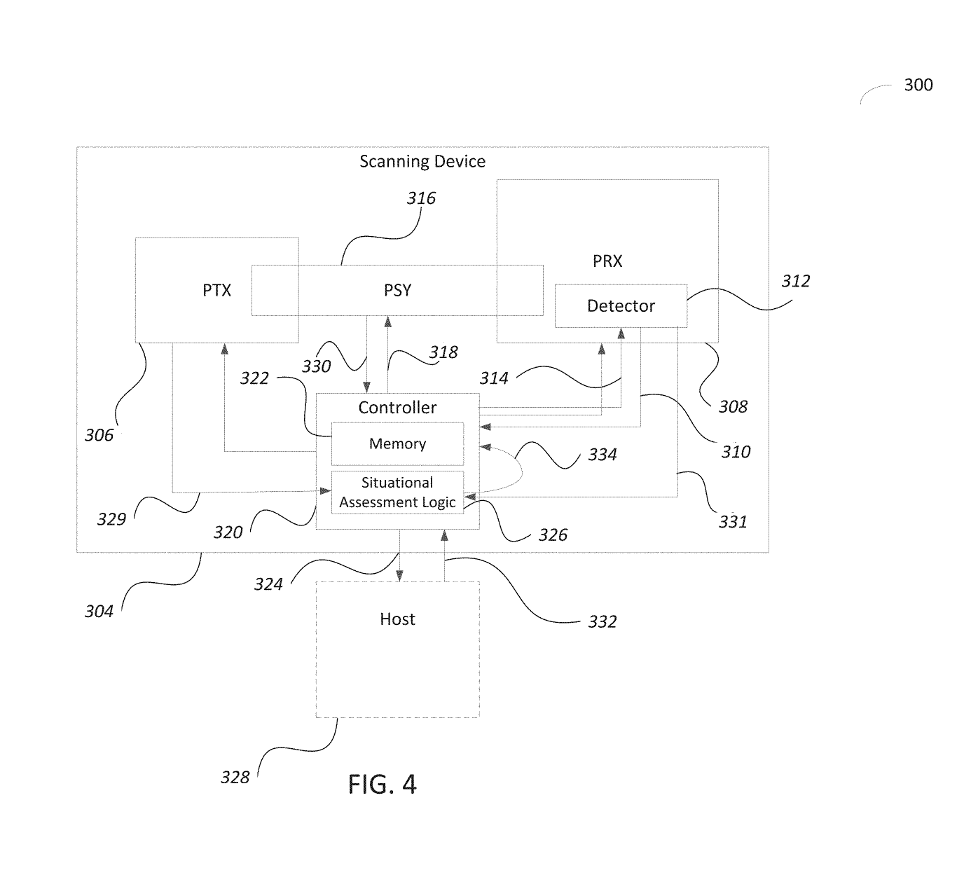

Turning to FIG. 4, depicted is an example scanning system 300 in accordance with some embodiments. It is understood that elements 304-326 and 334 are substantially similar to elements 104-126 and 134 of FIG. 2 (appropriately) and that the description of those elements are applicable to elements 304-326 and 334. Scanning system 300 may include host 328 in conjunction to which scanning device 304 may operate. It is understood that host 328 may be a part of scanning system 300 or may be associated with scanning device 304 and that the following description is applicable to either embodiments.

According to some embodiments, SAL 326 may receive detected scene signal 310 from detector 312 as well as information from additional blocks/elements either internal or external to scanning device 304, these signals and information will now be discussed in more detail.

According to some embodiment, SAL 326 may receive a PTX feedback 329 indicating PTX associated information such as an operational state, power consumption, temperature and more.

According to some embodiment, SAL 326 may receive a PRX feedback 331 indicating PRX associated information such as power consumption, temperature, detector state feedback and more.

According to some embodiments, SAL 326 may receive one or more feedback signals from PSY 316 via PSY feedback 330. PSY feedback 330 may include: PSY operational state, instantaneous position of PSY 316 where PSY 316 may include one or more reflecting elements and each reflecting element may contain one or more axis of motion, it is understood that the instantaneous position may be defined or measured in one or more dimensions. Typically, PSY's have an expected position, however PSY 316 may produce an internal signal measuring the instantaneous position (meaning, the actual position) then providing such feedback may be utilized by situational assessment logic 326 for calculating drifts and offsets parameters in the PRX and/or for correcting steering parameters control 318 of PSY 316 to correct an offset.

According to some embodiments, PSY feedback 330 may include instantaneous scanning speed of PSY 316. PSY 316 may produce an internal signal measuring the instantaneous speed (meaning, the actual speed and not the estimated or anticipated speed) then providing such feedback may be utilized by situational assessment logic 326 for calculating drifts and offsets parameters in the PRX and/or for correcting steering parameters control 318 of PSY 316 to correct an offset.

According to some embodiments, PSY feedback 330 may include instantaneous scanning frequency of PSY 316. PSY 316 may produce an internal signal measuring the instantaneous frequency (meaning, the actual frequency and not the estimated or anticipated frequency) then providing such feedback may be utilized by situational assessment logic 326 for calculating drifts and offsets parameters in the PRX and/or for correcting steering parameters control 318 of PSY 316 to correct an offset. The instantaneous frequency may be relative to one or more axis.

According to some embodiments, PSY feedback 330 may include mechanical overshoot of PSY 316, which represents a mechanical decalibration error from the expected position of the PSY in one or more axis. PSY 316 may produce an internal signal measuring the mechanical overshoot then providing such feedback may be utilized by situational assessment logic 326 for calculating drifts and offsets parameters in the PRX and/or for correcting steering parameters control 318 of PSY 316 to correct an offset. PSY feedback may also be utilized in order to correct steering parameters in case of vibrations induced by the LiDAR system or by external factors such as vehicle engine vibrations or road induces shocks.

According to some embodiments, PSY feedback 330 may be utilized to correct steering parameters 318 to correct the scanning trajectory and linearize it. The raw scanning pattern may typically be non-linear and may contain artifacts resulting from fabrication variations and the physics of the MEMS mirror or reflective elements. Mechanical impairments may be static (for example a variation in the curvature of the mirror) and/or dynamic (for example mirror warp/twist at the scanning edge of motion). Correction of the steering parameters to compensate for these non-linearizing elements may be utilized to linearize the PSY scanning trajectory.

According to some embodiments, SAL 326 may receive one or more host signals from host 328 via host feedback and information 332. Information received from the host may be additional information from other sensors in the system such other LiDARs, camera, RF radar, acoustic proximity system and more or feedback following processing of vision signal 324 at host 328 processing unit. Optionally, host information may be configured to override other SAL 326 inputs so that if a host indicates that a turn is expected, for example, scanning device 304 may analyze the upcoming turn. Optionally the host feedback may include an override command structure including a flag indicating that the host input is to override the internal feedbacks and signals. The override structure may contain direct designation to scan certain portion(s) of the scene at a certain power that translates into the LiDAR range and more.

According to some embodiments, SAL 326 may receive one or more signals from memory 322. Information received from the memory may include laser power budget (defined by eye safety limitations, thermal limitations reliability limitation or otherwise); electrical operational parameters such as current and peak voltages; calibration data such as expected PSY scanning speed, expected PSY scanning frequency, expected PSY scanning position and more.

According to some embodiments, SAL 326 may be configured to produce a feedback parameter and/or a vision signal 324 utilizing digital signal processing, image processing and computer vision techniques.

According to some embodiments, SAL 326 may analyze information and take into consideration a plurality of different types of information such as: (a) thermal envelope which may constrain the working regime and performance of the LiDAR such as pixel rate, frame rate, detection range and FOV depth resolution (4D resolution), FOV and angular range, (b) identified road delimiters or other constant elements in the FOV of the scanning device, (c) object of interest tracking, (d) optical flow that determines, tracks and predicts global motion of the scene and individual element's motion in the scene, (e) localization data associated with the location of the scanning device which may be received from host 328, (f) volumetric effects such as rain, fog, smoke, or otherwise; (g) interference such as ambient light, sun, other LiDARs on other hosts and more; (h) Ego-motion parameters from the host 328 associated with a host's steering wheel, blinkers or otherwise; (i) fusion with camera or other sensor associated with host 328 and more.

According to some embodiments, SAL 320 may output to a host device vision signal 324. The controller and/or SAL may analyze process and refine detected scene signal 310 by utilizing digital signal processing, image processing and computer vision techniques. Vision signal 324 may be a qualified point data structure (e.g., cloud map and or point cloud or otherwise). And may contain parameters not restricted to a 3D positioning of the pixels in the FOV, reflectivity intensity, confidence level according to a quality of service metric, metadata layer of identified objects to a host system. A quality of service metric may be an indication of system expected QOS and may be applicable, for example when the scanning device is operating in a low QOS to compensate for high surrounding temperatures or otherwise. According to some embodiments, scene signal 310 may be assessed and calculated accordingly. with or without additional feedback signals such as PSY feedback 330 PTX feedback 329, PRX feedback 331 and/or host feedback and information 332, according to a weighted means of local and global cost functions that determine a scanning/work plan such as work plan signal 334 for scanning device 304 (such as: which pixels in the FOV are scanned, at which laser parameters budget, at which detector parameters budget). Accordingly, controller 320 may be a closed loop dynamic controller that receives system feedback and updates the system's operation based on that feedback.

Accordingly, steering parameters of PSY 316, detector parameters of detector 312 and/or pulse parameters of PTX 306 may be updated based on the calculated/determined work plan 334. Work plan 334 may be tracked and determined at specific time intervals and with increasing level of accuracy and refinement of feedback signals.

According to some embodiments, updating of the parameters (steering, detector and/or laser pulse) based on work plan 334 may be updated in predetermined times or intervals, may be synchronous or asynchronous and may be dependent on work plan 334 itself, meaning that if a high priority update is received the update may be asynchronous and if not, it may be updated at a predetermined time.

According to some embodiments, work plan 334 may be updated based on real time detected scene information which may also be termed as pixel information. Real time information may analyze detected fast signals during time of flight that contains one or more reflections for a given photonic inspection pulse. For example, an unexpected detected target in a low priority field may cause controller 318 to update the pulse frequency of the laser of PTX 306 via updating of the pulse parameters. Work plan 334 may also be updated a frame or sub-frame level which may be information received accumulated and/or analyzed within a single frame. Furthermore, work plan 334 may be updated on an inter-frame level, which is information accumulated and analyzed over two or more frames. Increased levels of real time accuracy, meaning that work plan 334 is updated in a pixel or sub-frame resolution, is carried out when higher levels of computation produce increasingly usable results. Increased level of non-real time accuracy within a specific time period as slower converging data becomes available (e.g. computer vision generated optical flow estimation of objects over several frames), meaning that work plan 334 may be updated as new information becomes evident based on an inter-frame analysis.

According to some embodiments, controller 320 may adjust operation of PTX 306, such as: (a) inspection pulse intensity; (b) inspection pulse duration; (c) inspection pulsing patterns; and (d) more, for a given scene segment based on: (a) ambient light conditions; (b) pre-pulse reading on PRX; (c) energy level of prior reflected inspection pulse from same or nearby scene segment; and (d) relevance value of the given scene segment. Controller 320 may adjust operation of PRX 308, such as (a) photonic sensor selection, (b) photonic sensor biasing, (c) photonic sensor operation timing with respect to the PTX operation timing and with respect to the scene segment, (d) photon sensor output processing, and more for a given scene segment based on: (a) corresponding photonics inspection pulse intensity; (b) pre-pulse reading on PRX photonic sensor(s); (c) energy level of prior reflected inspection pulse from same or nearby scene segment; (d) current scanning direction of photonic steering assembly being used and more. Controller 320 may adjust operation of PSY 316, such as: scanning method that defines the acquisition pattern and sample size of the scene, power modulation that defines the range accuracy of the acquired scene, correction of axis impairments based on collected feedback, calibration of steering to expected characteristics and more.

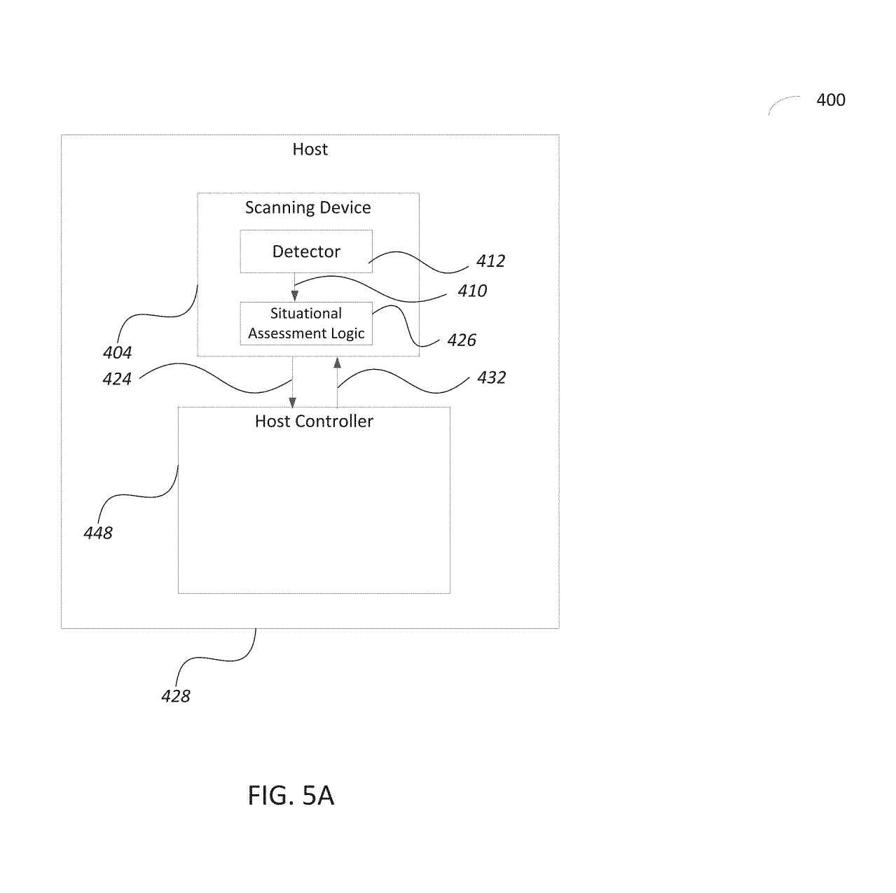

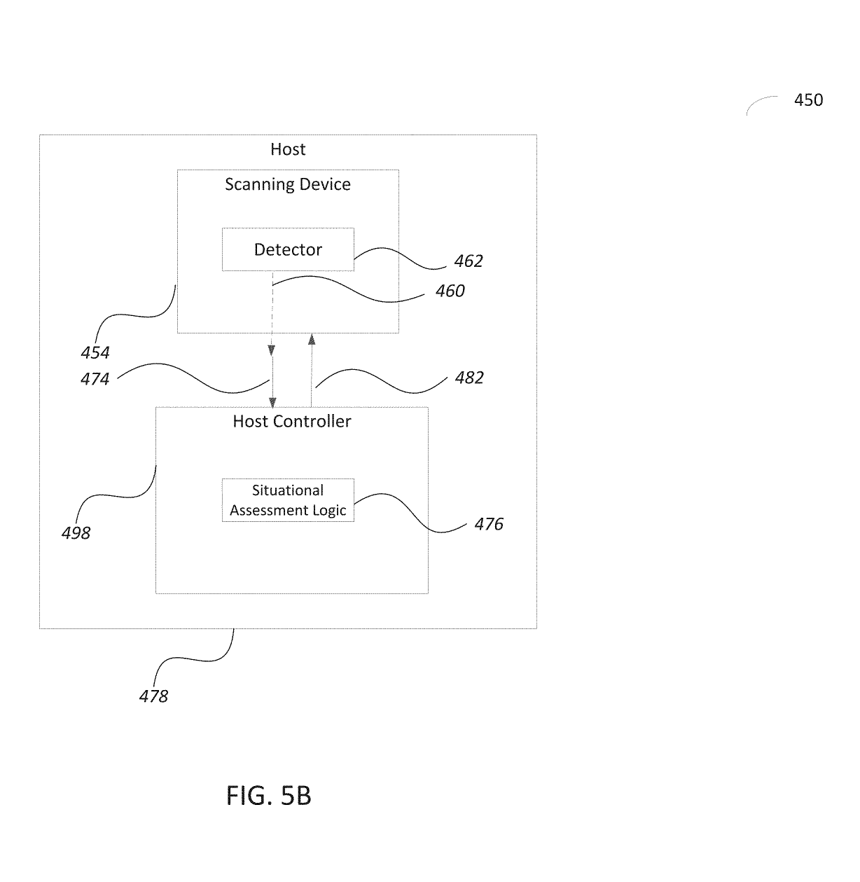

Turning to FIGS. 5A&5B depicted are host systems 400 and 450 including host 428 and 478, respectively. It is understood that elements 404-432 of FIG. 5A and elements 454-482 of FIG. 5B are substantially similar to elements 304-332 of FIG. 4 and that the discussion of those elements is applicable to elements 404-432 and 454-482, appropriately. Furthermore, host 428 and 478 includes host controller 448 and 498 (respectively). It is understood that scanning devices 404 and 454 each include all of the sub elements depicted in FIG. 4 with regard to scanning device 304 and are not detailed here for clarity, detailed are the blocks currently being discussed. Differences from FIG. 4 will be discussed below.

According to some embodiments, hosts 428 and/or 478 may each be a vehicle or a drone.

With regard to FIG. 5A, according to some embodiments, host 428 may receive vision signal 424 and relay to scanning device host feedback and information 432, which may include information from additional host modules such as additional scanning devices, sensors, cameras, host steering system, host controller 448 and more.

With regard to FIG. 5B, according to some embodiments, at least part of the situational assessment logic functionality, discussed with regard to FIG. 4, for example, may be executed in/or implemented by host controller 498 instead of scanning device 454. Accordingly, scene signal 460 (or a derivative of scene signal 460, hence the dashed line may be relayed to host controller 498 and the rest of the analysis carried out at the host controller's SAL 476.

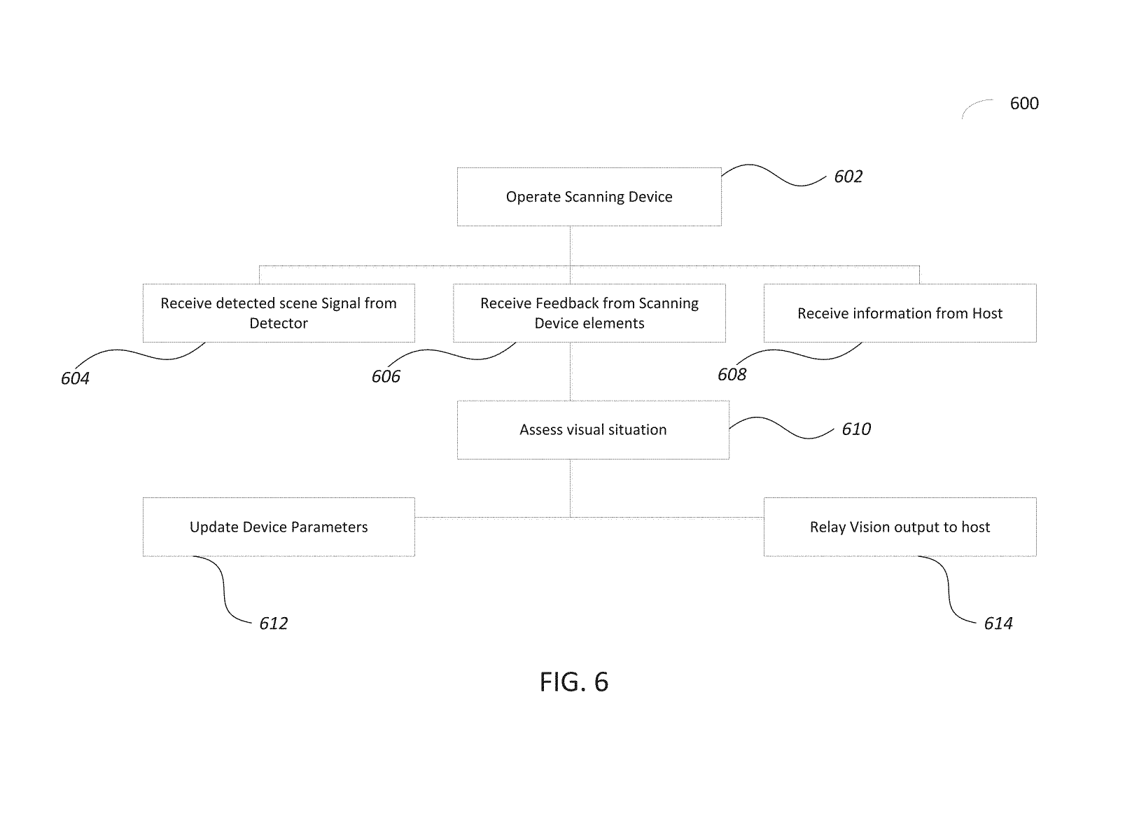

Turning to FIG. 6, shown is a flow chart 600 for a method of scanning a scene according to some embodiments. A scanning device may be operated based on default values or an initial signal(s) for scanning parameters (602). As a result of scanning a scene a detected scene signal is received/detected from a detector associated with the scanning device (604). Furthermore, one or more elements of a scanning device may be configured to provide feedback regarding operation of the elements of a scanning device (606) and a host device associated with the scanning device may provide additional information (608) such as host information and feedback regarding additional elements of the host (additional scanning devices, sensors and more). Based on the received signals and information a visual situation may be assessed (610) either by the scanning device, by the host or a combination of the two. Based on the visual situation the scanning parameters may be updated (612) causing the scanning device to scan a scene based on the visual situation. The visual situation or a signal associated with the visual situation may be relayed to a host.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A scanning device comprising:
a photonic emitter assembly (PTX) to emit at least one pulse of inspection photons in accordance with at least one adjustable pulse (generation) parameter; a photonic reception and detection assembly (PRX) to receive reflected photons reflected back from an object, said PRX including a dynamic detector to detect the reflected photons based on one or more adjustable detector parameter, said detector further configured to and produce a detected scene signal;
a photonic steering assembly (PSY) functionally associated with both said PTX and said PRX to direct said pulses of inspection photons in a direction of an inspected scene segment and to steer said reflection photons back to said PRX; and
a closed loop controller to control said PTX, PRX and PSY and to receive a PTX feedback, a PRX feedback and a PSY feedback, said controller further comprising a situational assessment unit to receive said detected scene signal from said detector and produce a scanning plan and update said at least one pulse parameter and at least one detector parameter at least partially based on said scanning plan.

2. The scanning device of claim 1, wherein said at least one pulse parameter is selected from the group consisting of: pulse power intensity, pulse width, pulse repetition rate, pulse sequence, pulse duty cycle, wavelength, phase and polarization.

3. The scanning device of claim 1, wherein said situational assessment unit is further configured to produce said scanning plan based on said PSY feedback from said PSY.

4. The scanning device of claim 3, wherein said situational assessment unit is further configured to receive information stored on a memory, said information selected from the list consisting of: laser power budget, electrical operational characteristics and calibration data.

5. The scanning device of claim 1, wherein said scanning plan is produced based on (a) real-time detected scene signal (b) intra-frame-level scene signal and (c) inter-frame level scene signal accumulated and analyzed over two or more frames.

6. The scanning device of claim 1, wherein said detector parameters are selected from the group consisting of: scanning direction, frame rate, ambient light effects, mechanical static and dynamic impairments and thermal effects.

7. The scanning device of claim 1, wherein said PSY has one or more steering parameters and said closed loop controller is further configured to update said steering parameters based on said scanning plan.

8. The scanning device of claim 7, wherein said steering parameters are selected from the group consisting of: scanning method, power modulation, single or multiple deflection axis methods, synchronization components.

9. The scanning device of claim 1, wherein said situational assessment unit is configured to receive a host feedback from a host device and to use said host feedback to produce said scanning plan.

10. The scanning device according to claim 1, wherein said situational assessment unit is configured to determine said scanning plan based on a global cost function wherein PSY feedback, PRX feedback, PTX feedback, memory information, host feedback and said detected scene signal are used in producing said scanning plan wherein said host feedback includes an override flag.

11. A method of scanning a scene comprising:
producing pulses of inspection photons wherein said pulses are characterized by at least one pulse parameter;
receiving reflected photons reflected back from an object;
detecting the reflected photons and producing a detected scene signal; and
updating at least one pulse parameter based on said detected scene signal.

12. The method of claim 11, wherein said at least one pulse parameter is selected from the group consisting of: pulse power intensity, pulse width, pulse repetition rate pulse sequence, pulse duty cycle, wavelength, phase and polarization.

13. The method of claim 11, further comprising producing a work plan based on said detected scene signal.

14. The method according to claim 13, wherein said producing a work plan is also based on a PSY feedback.

15. The method according to claim 14, wherein said producing a work plan is also based on information stored on a memory, wherein said information selected from the list consisting of: laser power budget, electrical operational characteristics and calibration data.

16. The method according to claim 15, wherein said producing a work plan is produced based on (a) real-time detected scene signal (b) intra frame-level scene signal and (c) inter-frame level scene signal accumulated and analyzed over two or more frames.

17. The method according to claim 15, further comprising updating one or more detector parameters based on said work plan.

18. The method according to claim 15, further comprising updating steering of the PSY based on said work plan.

19. A vehicle comprising:
a scanning device including:
a photonic emitter assembly (PTX) to produce pulses of inspection photons wherein said pulses are characterized by at least one pulse parameter;
a photonic reception and detection assembly (PRX) to receive reflected photons reflected back from an object, said PRX including a detector to detect the reflected photons and produce a detected scene signal;
a photonic steering assembly (PSY) functionally associated with both said PTX and said PRX to direct said pulses of inspection photons in a direction of an inspected scene segment and to steer said reflection photons back to said PRX;
a closed loop controller to: (a) control said PTX, PRX and PSY, (b) receive said detected scene signal from said detector, and (c) update said at least one pulse parameter at least partially based on said detected scene signal; and
a host device to receive said detected scene signal and control said vehicle at least partially based on said detected scene signal and to relay a host feedback to said scanning device,
wherein said situational assessment unit is configured to receive a host feedback from said host device and to use said host feedback to produce said work plan.
